(19) United States
(12) Patent Application Publication
(10) Pub. No.: US 2006/0247851 A1
(43) Pub. Date: Nov. 2, 2006

(54) Mobile phone having a TV remote style user interface

(76) Inventor: Robert P. Morris, Raleigh, NC (US)

Correspondence Address: SCENERA RESEARCH, LLC, 111 Corning Road, Suite 220, Cary, NC, 27511, US

(21) Appl. No.: 11/076,470

(22) Filed: Mar. 8, 2005

(51) Int. Cl. G01C 21/30; G01C 21/32

(52) U.S. Cl. 701/209

(57) ABSTRACT

The present invention provides an improved mobile device user interface. Aspects of the present invention include associating at least a portion of destinations that are reachable via the devices user interface with a respective channel, and creating a channel table for indicating which destinations are assigned to which channels; and providing the mobile device with at least one control for sequentially changing the channels independently of display of the channel table, thereby allowing the user to switch between destinations based on a TV remote metaphor.

### FIELD OF THE INVENTION

The present invention relates to mobile phones, and more particularly to a method and system for providing a mobile phone with a TV remote user interface.

### BACKGROUND OF THE INVENTION

Mobile devices, such as mobile phones, PDAs, cameras, etc., are being equipped with an ever growing number of features, functions, and content. Typically, each is provided by an application program that is invoked when the user activates the corresponding feature, function, or content. However, studies of how users use their mobile devices show that most users use only a small number of the features, functions, and/or content on the device.

Standard graphical user interfaces (GUI's) on mobile devices use two popular methods for allowing users to find and activate features. One method provides special purpose keys that the user can associate with a specific feature, such as an address book or a camera feature on a camera phone. Another GUI method uses metaphors which relate to hierarchies to organize the features on the device (folders, trees, menus etc). The Web is another metaphor with a set of destinations linked together in any way chosen by the creators of the destinations.

Each of these methods has disadvantages. GUIs that provide special purpose keys, “such as hot keys,” for certain features allow a user to quickly invoke a common task, only a limited number of such keys can be provided due to limited space on the device. In addition, these special-purpose buttons are typically not configured by the user. And even if they were, many users do not take the time to learn how to set them.

Providing a list of features inside a menu hierarchy is common for computers, but today's multifunction mobile devices have so many features that it can be difficult with current mobile device GUIs for most users to determine where to find the feature and what features are present on the device. In addition, many users are reluctant to explore the menu hierarchies to search for features because exploring menus can be unfamiliar, especially for users who are accustomed to talking on a phone, but not using a computer. Also, when navigating hierarchical menus, it can be hard for users to know where they are in the menu hierarchy. Similarly, it is easy to get lost on the web or to forget how you got to a particular destination. Searches and bookmarks must be used to locate desired destinations.

Accordingly, there is need for an improved user interface for mobile devices.

### BRIEF SUMMARY OF THE INVENTION

The present invention provides an improved mobile device user interface. Aspects of the present invention include associating one or more heterogeneous destinations reachable by the mobile device with a respective channel, and creating a channel table for indicating which destinations are assigned to which channels; and providing the mobile device with buttons for sequentially changing the channels independently of display of the channel table, thereby allowing the heterogeneous destinations to be changed directly based on a TV remote metaphor.

A destination is any application, file, web page, or portion thereof which can be reached on a mobile device through its navigation controls. For, example, any object with a URL may be a destination. A contact entry in an address book may be a destination. Elements of a contact entry such as a phone number may be destinations. A file stored either locally or remotely may be a destination. An image in a photo album may be a destination.

A channel is a metaphor used to refer to the association of a destination with an identifier in an ordered destination set. Each destination is referred to a channel much as a television channel is associated with an identifier from a set of available identifiers on a television, cable, or radio. Given the definition of a destination, it is clear that the ordered destination set can be a heterogeneous set as opposed to the set of channels on a TV, radio, etc in that the channels on current devices are all of the same type; a TV broadcast, a radio, broadcast, a web URL in the case of a browser bookmarks list, and menus items, etc.

According to the method and system disclosed herein, the user interface uses the metaphor of a well-known interface, a TV remote, that provides users with a high comfort level, the UI allows browsing and direct navigation to a destination (aka channel), and the UI can be integrated with a traditional UI to allow the user to navigate the traditional UI when desired or needed.

### BRIEF DESCRIPTION OF SEVERAL VIEWS OF THE DRAWINGS

FIG. 1 is a flow diagram illustrating the process for providing a mobile device with a heterogeneous channel set user interface in accordance with a preferred embodiment of the present invention.

FIGS. 2A and 2B are block diagrams illustrating a mobile device having a heterogeneous channel set user interface in accordance with a preferred embodiment of the present invention.

FIGS. 3A and 3B are block diagrams illustrating components of the mobile device for implementing the heterogeneous channel set user interface in accordance with a preferred embodiment.

FIG. 4 is a flow diagram illustrating the process the channel controller performs when the user switches channels using the channel up and down buttons in accordance with a first embodiment.

FIG. 5 is flow diagram illustrating the process the channel controller performs when the user displays the channel guide in accordance with the first embodiment.

FIG. 6 is a flow diagram illustrating the process the channel controller performs when the user switches channels using the channel up and down buttons in a multiprocessing mobile device in which multiple destinations run in the background.

### DETAILED DESCRIPTION OF THE INVENTION

The present invention relates to a mobile device user interface. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a GUI navigation system on a mobile computing device that is familiar to users, allows them to go directly to a desired destination, and allows them to browse all the applications, documents, web pages, and other destinations in a familiar style. More specifically, the present invention provides a user interface for a mobile device that is based on a television (TV) remote control metaphor that allows users to navigate through the destinations on the mobile device just as they would use a remote control to surf channels on a TV.

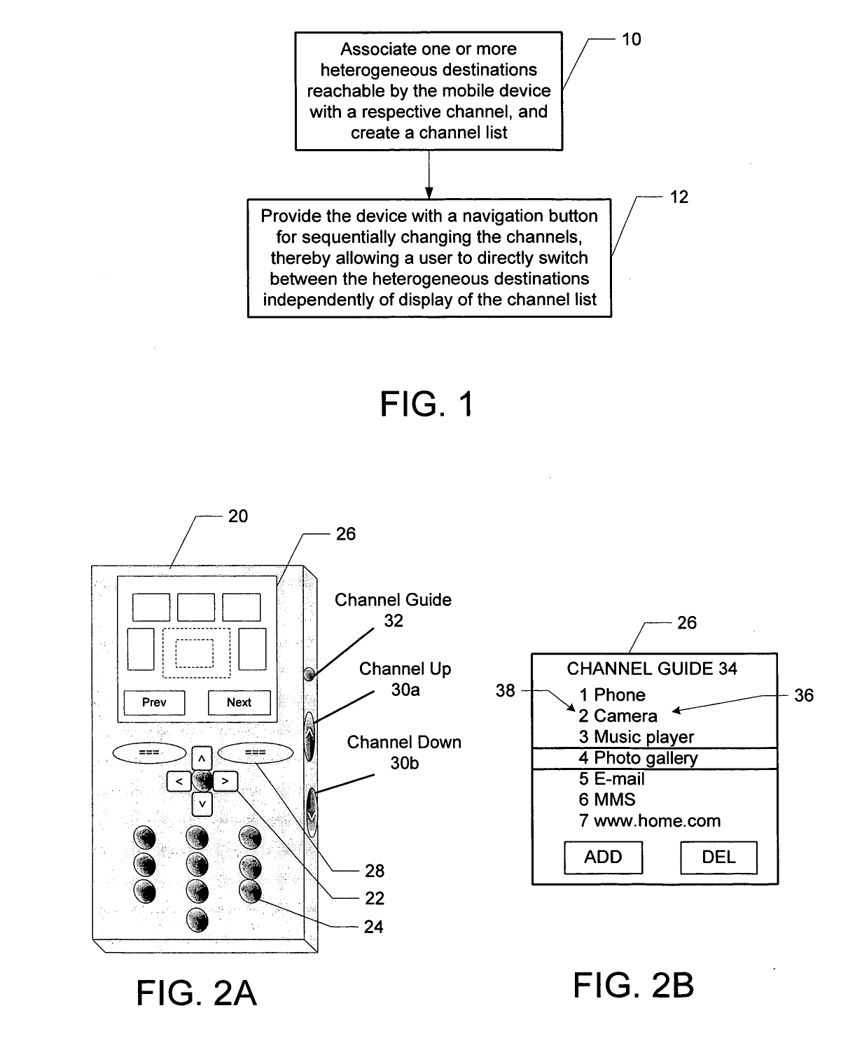

FIG. 1 is a flow diagram illustrating the process for providing a mobile device with a TV remote user interface in accordance with a preferred embodiment of the present invention. The process begins in step 10 in which one or more heterogeneous destinations reachable by the mobile device are associated with a respective channel. As used herein, the term “destination” may apply to any feature, function, or mode of the device, which are typically implemented by various software applications, as well as locations of files and web pages via file paths and uniform resource locators (URLs). In this sense, destinations are heterogeneous in terms of function, content, and access method. A destination is any of the above that can be located on a mobile device using its navigation controls and menus. A channel is a metaphor used to refer to the association of a destination with an identifier in an ordered destination set. Each destination is referred to a channel much as a television channel is associated with an identifier from a set of available identifiers on a television, cable, or radio (e.g., A, B, . . . 1, 2, 3 . . . ). The association steps includes the creation of a channel table, referred to herein as a channel guide, for indicating which destinations are assigned to which channels. In step 12, the device is provided with a directional control for sequentially changing the channels independently of display of the channel table, thereby allowing a user to directly switch between the heterogeneous destinations. In a preferred embodiment, the mobile device is provided with dedicated up/down buttons that are separate from the traditional navigational control button, whose sole purpose is to change channels no matter what state or mode the mobile device is in.

FIGS. 2A and 2B are block diagrams illustrating a mobile device having a TV remote style user interface in accordance with a preferred embodiment of the present invention. FIG. 2A is a diagram showing the hardware components of the mobile device 20, which in a preferred embodiment is a multifunction device capable of invoking different destinations and wireless communication, such as a cell phone, but may be any such device such as a wireless PDA or camera. Standard hardware user interface components of the mobile device 20 include a four-way navigation button 22, a keypad 24, a display 26 and soft keys 28.

According to the preferred embodiment, the mobile device 20 is also provided with channel up and down buttons 30a and 30b that a user can use to browse destinations by simply pressing the channel up-and-down buttons 30a and 30b to change channels. The mobile device 20 may also be provided with a channel guide button 32. As shown in FIG. 2B, when depressed, the channel guide button 32 causes a channel guide 34 to be shown on the display 26 that shows each of the specified destinations 36 of the mobile device 20 and a corresponding channel number or ID 38. Examples of destinations that may be provided on the mobile phone include a phone, a camera, a music player, a photo gallery, e-mail, text messaging, URL bookmarks, and local files including destinations within the applications, web pages, and files. The channel guide 34 may also show labels over the soft keys 28 for adding and deleting channels, which are activated by pressing the corresponding soft keys 28.

Several options may be provided for the channel guide 34. One option enables the channel guide 34 to provide a brief description of each channel. A dedicated “information” button (not shown) similar to a cable guide remote may be provided for this function or a brief description may be displayed next to each feature. Another option allows the user to customize the list of channels shown by the channel guide 34 so that only the destinations that the user uses are shown. The manufacturer of the phone or an Internet ISP can also provide a special channel where new services and information and other destinations are advertised and the user can add them as new channels. Similarly, an ISP can simply add new channels as a way of advertising new features and services. The user may keep or remove them.

The user may change channels and therefore change destinations using several methods. One method for changing channels is for the user to simply press the channel up and down buttons 30a and 30b. As stated above, each destination is associated with a particular channel number or ID. Pressing the channel up button switches to a next higher channel, and pressing the channel down button switches to a lower channel. Assuming, for example, that the photo gallery feature is active on the mobile device 20, which is shown in FIG. 2B as being channel 4, pressing the channel up button 30a would switch to channel 5 and activate the e-mail destination, while pressing the channel down buttons 30b would switch to channel 3 and activate the music player destination.

A second method for changing channels is by pressing the channel guide button 32 to display the channel guide 34. Using the four-way navigation a button 22, or optionally the channel up-and-down buttons 30a and 30b, the user may then scroll through the channel guide 34 until the desired feature is found. As the user scrolls through the channels each channel may be highlighted. The user may then activate the highlighted channel by pressing a select or enter button. In the example shown, the user has scrolled to the photo gallery feature. Activating the photo gallery feature causes images stored on the mobile device to be displayed on the display 26, as shown in FIG. 2A.

A third method for changing channels is for the user to enter a desired channel number or ID using the keypad 24, which allows the user to go directly to a desired channel without sequentially scrolling through the channels. The mobile device 20 may distinguish user-entered channel numbers from entered phone numbers by requiring that the user press the select button rather than a call or talk button after the number is entered. The mobile device 20 may also distinguish between user-input channel numbers and phone numbers by the length of the number and a pause where no input is received.

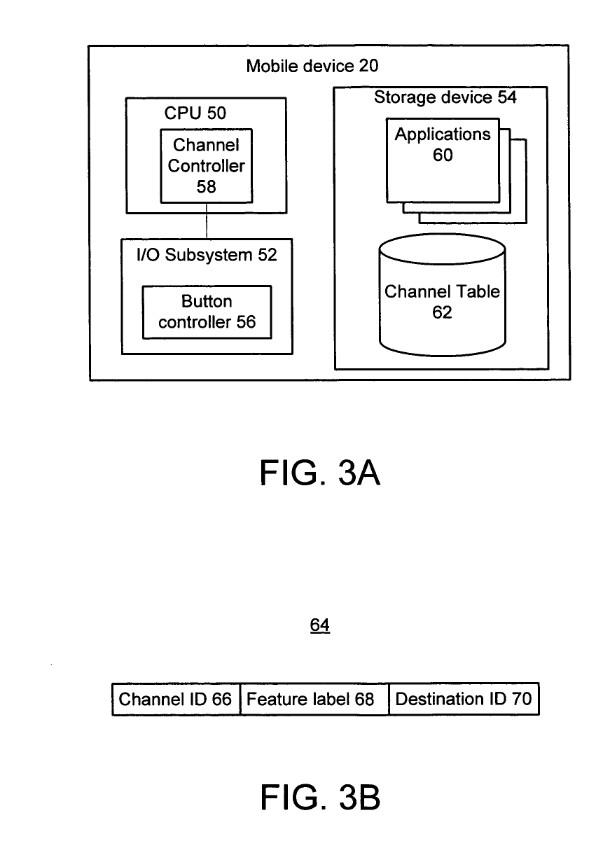

FIGS. 3A and 3B are block diagrams illustrating components of the mobile device 20 for implementing the TV remote style user interface in accordance with a preferred embodiment. The mobile device 20 includes a processor 50 for executing software programs, an I/O subsystem 52, and a storage device 54. The storage device 54 includes application programs 60 that implement the features of the mobile device 20, and a channel table 62.

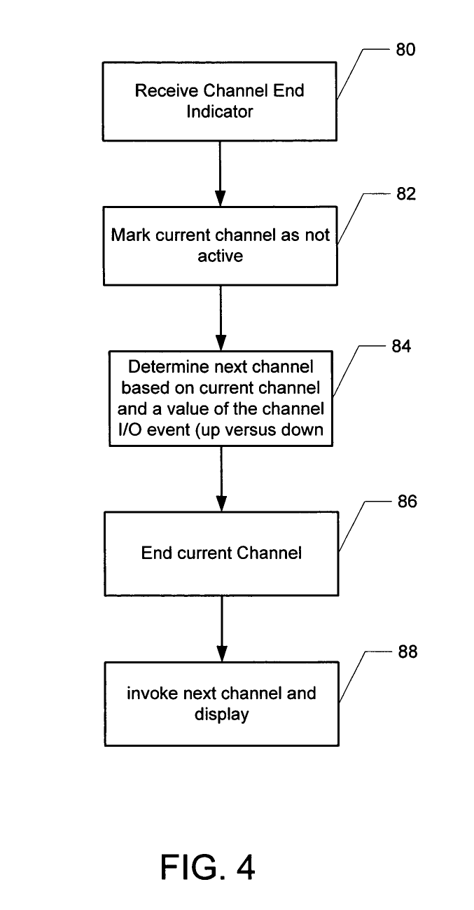

The I/O subsystem 52 refers to a set of devices and software components that operate together to provide data transfer services for the mobile device 20. The I/O subsystem 52 includes a button controller 56 coupled to the hardware user interface components that detects button events and identifies the button pressed. A channel controller 58 executing on the processor 50 receives input from the button controller 56 and interprets the context of button press. Based on the interpretation of the button event, the channel controller 58 accesses the channel table 62 and takes the appropriate action, as described with respect to FIGS. 4, 5 and 6.

The channel table 62 includes records that associate the channels with corresponding destinations. FIG. 3B is a diagram showing the preferred format of the records 64 in the channel table 62. Each channel record 64 preferably includes a channel ID 66, a label 68 for displaying, and an ID, URL, or path of the corresponding destination 70. The channel ID 66 and the label 68 of the channel are displayed in the channel guide (FIG. 2A). In a preferred embodiment, the IDs, URLs, or paths of the destinations 70 are all in the form of a uniform resource locator (URL).

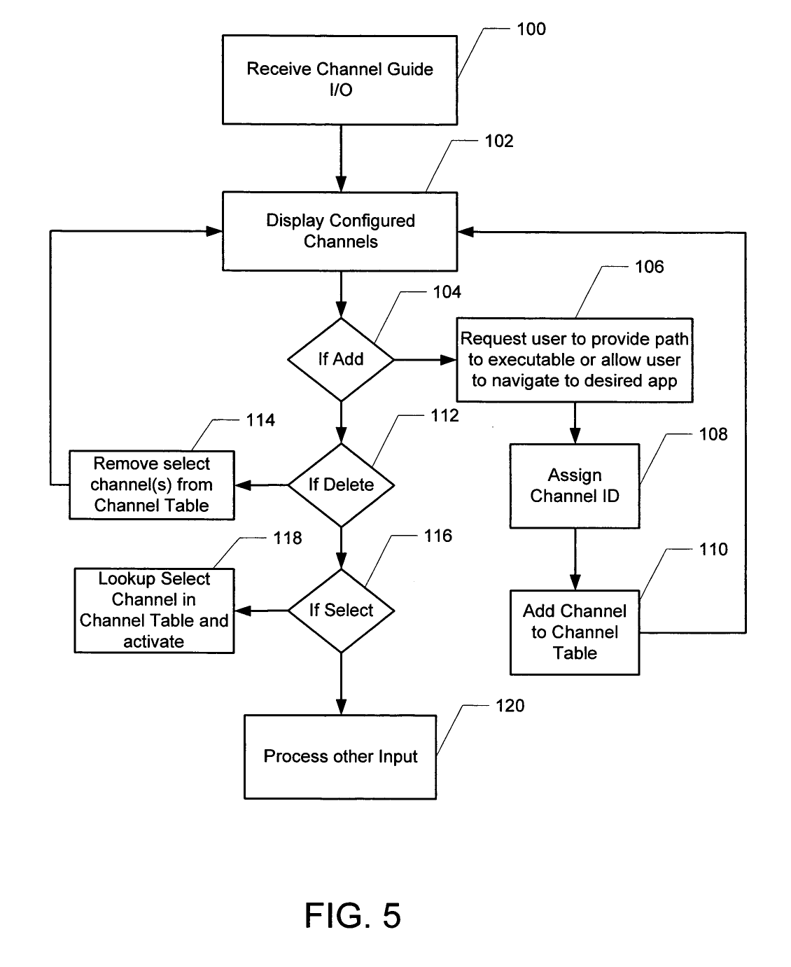

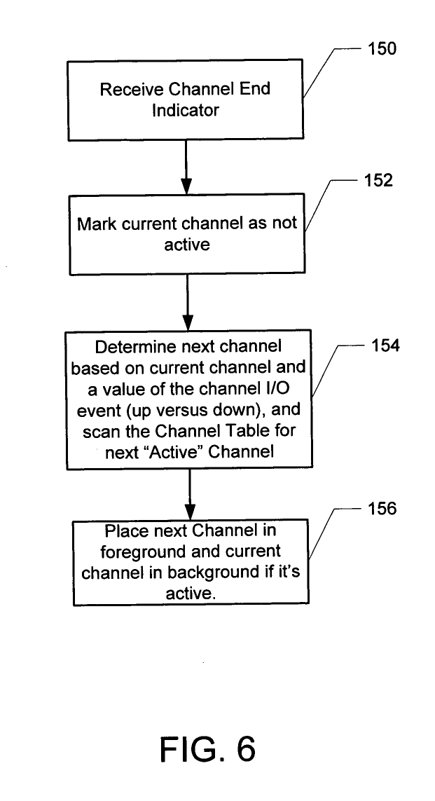

In a first preferred embodiment, the mobile device 20 is only capable of running one destination 70 at a time. In this case, changing channels terminates the current destination 70 and invokes the destination 70 corresponding to the selected channel. In a second preferred embodiment, the mobile device 20 is capable of multiprocessing multiple active channels in which case the active channel runs in the foreground and the others run in the background. In this embodiment, the channel guide 34 may only display active channels. Other embodiments exist such an embodiment where multiprocessing is supported and the channels navigate through both active and inactive channels. FIGS. 4 and 5 are diagrams illustrating the process of switching channels according to the first embodiment where the device is only capable of invoking one destination at a time. FIG. 6 is a diagram illustrating the process of switching channels by a multiprocessing mobile device according to the second embodiment.

FIG. 4 is a flow diagram illustrating the process the channel controller 58 performs when the user switches channels using the channel up and down buttons 30a and 30b in accordance with the first embodiment or simply exits the currently displayed destination for example by closing it. The user may preferably switch channels using the channel up and down buttons 30a and 30b at any time regardless of which destination 70 is currently active. The process begins in step 80 when the channel controller 58 receives an I/O from the button controller 56 indicating a channel up/down 30 event has occurred or the current destination has been closed, and interprets the event as a channel end indicator of the current destination. In response, in step 82 the channel controller 58 marks the current channel as not active. In step 84, the channel controller 58 determines the next channel based on the current channel and a value of the channel I/O event (up versus down, or the default direction in case of a close operation). In step 86, the destination 70 associated with current channel is terminated. And in step 88, the destination 70 associated with the next channel is invoked and displayed. Note when a channel is deactivated through means other than the up/down 30 events, the next channel is activated where next is determined via a configuration setting typically indicating the default event (up or down).

FIG. 5 is flow diagram illustrating the process the channel controller 58 performs when the user displays the channel guide in accordance with the first embodiment. In a preferred embodiment, the channel guide 34 displays a list of available channels, and allows the user to add, remove, modify, and select channels. The process begins in step 100 when the channel controller 58 receives an I/O from the button controller 56 indicating a channel guide button 32 event has occurred. In step 102, the channel controller 58 accesses the channel table 62 and displays the channel guide 26. In step 104, the channel controller 58 determines if the user has pressed the “add” soft key to add a channel. If the channel controller 58 did receive an “add” button event, then in step 106 the user is requested to specify a destination by providing a URL to the desired destination. In step 108, the channel controller 58 assigns a channel ID to the specified destination. The channel ID may be assigned to the specified destination either automatically by the mobile device 20 or manually by the user. In one embodiment, the channel guide 34 may be downloaded from a service such as an Internet service provider (ISP). In step 110, the channel controller 58 creates a channel record for the new channel and adds the record to the channel table 62. The process than continues by displaying the updated channel guide 34 in step 102.

In another variation, the user may navigate to the desired destination, then select add channel from an available menu. The destination may be added automatically with ID and label automatically assigned or the user may be prompted to provide a label and change the indicated channel ID.

In step 112 the channel controller 58 determines if the user has pressed the “delete” soft key to delete a channel. If so, then in step 114 the channel controller 58 removes the selected channel(s) from the channel table 62, and the updated channel guide 34 is displayed in step 102. In step 116 the channel controller 58 determines if the user has pressed the “select” or “enter” key to select a channel from the channel guide 34. If so, then in step 118, the channel controller 58 looks up the selected channel in the channel table 62 using the channel ID and activates the corresponding destination. In step 120, the channel guide processes other input key events as needed, such as deactivating the channel guide 34 when the channel guide button 32 is pressed while the channel guide 34 is displayed.

In another variation, the user may navigate to a destination, the system determines if the destination matches a destination in the channel guide. If there is a match, menu items are provided that allow the user to delete and/or modify the associated channel.

FIG. 6 is a flow diagram illustrating the process the channel controller 58 performs when the user switches channels using the channel up and down buttons 30a and 30b using a multiprocessing mobile device in which multiple destinations run in the background. Although the channel table 62 may contain records for many channels, in a preferred embodiment only active channels can be switched to using the channel up and down buttons 30. The process begins in step 150 when the channel controller 58 receives an I/O from the button controller 56 indicating a channel up/down 30 event has occurred or the foreground destination has been closed. In step 152, the channel controller 58 determines the next channel based on the current channel and a value of the channel I/O event (up versus down, or default direction in the case of a close event), and scans the channel table 62 for the next “active” channel. In step 154, the next active channel is moved to the foreground and the current channel is moved to the background if it is still active.

Another embodiment for determining the content of the channel table is a system where channels are assigned based on actual usage. Highly used destinations are automatically assigned to channels. If a destination with an existing channel assignment is not used for some period of time, the system may automatically remove it. One skilled in the art will recognize that there a many methods which may be used for populating the channel table.

A method and system for providing a mobile device with a TV remote style user interface has been disclosed. The TV remote style user interface provides the following advantages: 1) The UI is based on a well-known interface that provides users with a high comfort level. 2) The UI can be restricted to only desired destinations. 3) The UI allows browsing and direct connection to a destination. 4) And the UI can be integrated with a traditional UI to allow the user to navigate the traditional hierarchical UI when desired or needed.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We Claim:

1. A method for providing a mobile device user interface, comprising:
associating one or more heterogeneous destinations that are reachable through the device's UI with a respective channel, and creating a channel table for indicating which destinations are assigned to which channels; and
providing the mobile device with at least one directional control for changing the channels independently of display of the channel table, thereby allowing the heterogeneous destinations to be changed directly.

2. The method of claim 1 further including: automatically associating the heterogeneous destinations with the channels.

3. The method of claim 2 further including: allowing the user to associate the heterogeneous destinations with the channels.

4. The method of claim 3 further including: providing the mobile device with a channel up button and a channel down button, wherein each heterogeneous destination is associated with a channel number, and pressing the channel up button switches to a next numerically higher channel, and pressing the channel down button switches to a numerically lower channel.

5. The method of claim 3 further including: providing mobile device with a channel guide button that when depressed causes a channel guide to be shown on a display of the mobile device showing heterogeneous destinations of the mobile device and the corresponding channel number.

6. The method of claim 5 further including: allowing the user go directly to a desired channel by entering the channel number using a keypad on the mobile device.

7. The method of claim 5 further including: allowing the user to change channels by,
pressing the channel guide button to display the channel guide; and
using a mobile device navigation button to scroll through the channel guide until the desired heterogeneous destination is found and activating the heterogeneous destination.

8. The method of claim 5 further including: associating any combination of the following heterogeneous destinationheterogeneous destinations with channels; a phone, a camera, a music player, a photo gallery, e-mail, text messaging, and URLs.

9. The method of claim 8 further including: displaying labels in the channel guide for allowing a user to add and delete channels.

10. The method of claim 5 wherein the mobile device is only capable of one active destination at a time, and changing channels terminates a current destination and invokes the destination corresponding to a selected channel.

11. The method of claim 5 wherein the mobile device is capable of multiprocessing multiple active channels in which case an active channel runs in a foreground and other active channels run in a background, and wherein the channel guide may only displays active channels.

12. A mobile device, comprising:
hardware user interface components including a navigation button, a keypad, a display, and at least one channel button;
an I/O subsystem including a button controller coupled to the hardware user interface component for detecting button events and an identity of the button pressed;
a storage device for storing destinations reachable via the device user interface, and a channel table that includes records for associating a plurality of channels with corresponding destinations; and
a processor for executing software programs including a channel controller and a current destination, wherein the channel controller receives input from the button controller and interprets button presses, such that in response to detecting a channel button event, the channel controller switches directly to a next channel independent of display of the channel table, causing the corresponding destination to be invoked.

13. The mobile device of claim 12 wherein the heterogeneous destinations are automatically associated with the channels.

14. The mobile device of claim 13 wherein the user is allowed to associate the heterogeneous destinations with the channels.

15. The mobile device of claim 14 wherein the mobile device further includes a channel guide button that when depressed causes a channel guide to be shown on a display of the mobile device showing heterogeneous destinations of the mobile device and the corresponding channel number.

16. The mobile device of claim 14 wherein the user can go directly to a desired channel by entering the channel number using a keypad on the mobile device.

17. The mobile device of claim 15 wherein the user can change channels by,
pressing the channel guide button to display the channel guide; and
using the navigation a button to scroll through the channel guide until the desired heterogeneous destination is found and activating the heterogeneous destination.

18. The mobile device of claim 15 wherein any combination of the following heterogeneous destinations are associated with the channels; a phone, a camera, a music player, a photo gallery, e-mail, text messaging, and URLs.

19. The mobile device of claim 18 wherein labels are displayed in the channel guide for allowing a user to add and delete channels.

20. The mobile device of claim 15 wherein the mobile device is only capable of one active destination at a time, and changing channels terminates the current destination and invokes the destination corresponding to a selected channel.

21. The mobile device of claim 15 wherein the mobile device is capable of multiprocessing multiple active channels in which case an active channel runs in a foreground and other active channels run in a background, and wherein the channel guide may only displays active channels.

22. The mobile device of claim 15 wherein each of the records in the channel cable includes a channel ID and an ID of the corresponding destination.

23. A method for providing a mobile device user interface, comprising:
providing the mobile device with at least one channel control;
allowing a user to associate destinations reachable via the device's user interface with respective channels, the associations being stored in a channel table for indicating which destinations are assigned to which channels; and
allowing the user to navigate among the channels using the channel control to select and activate-one of the destinations independently of display of the channel table.

24. The method of claim 23 further including: providing a cell phone as the mobile device.

25. The method of claim 24 further including: automatically associating the heterogeneous destinations of the mobile devices with the channels.

26. The method of claim 25 further including: providing the mobile device with a channel up button and a channel down button, and in response to the user pressing the channel up button, switching to a next numerically higher channel, and in response to the user pressing the channel down button, switching to a numerically lower channel.

27. The method of claim 26 further including: providing mobile device with a channel guide button that when depressed causes a channel guide to be shown on a display of the mobile device showing heterogeneous heterogeneous destinations of the mobile device and the corresponding channel number.

28. The method of claim 26 further including: allowing the user go directly to a desired channel by entering the channel number using a keypad on the mobile device.

29. The method of claim 26 further including: allowing the user to change channels by,
pressing the channel guide button to display the channel guide; and
using a mobile device navigation button to scroll through the channel guide until the desired heterogeneous destination is found and activating the heterogeneous destination.

30. The method of claim 26 further including: associating any combination of the following heterogeneous destinations with channels; a phone, a camera, a music player, a photo gallery, e-mail, text messaging, and URLs.

31. The method of claim 30 further including: displaying labels in the channel guide for allowing a user to add and delete channels.

32. The method of claim 26 wherein the mobile device is only capable of one active destination at a time, and changing channels terminates a current destination and invokes the destination corresponding to a selected channel.

33. The method of claim 26 wherein the mobile device is capable of multiprocessing multiple active channels in which case an active channel runs in a foreground and other active channels run in a background, and wherein the channel guide may only displays active channels.
